(19) United States
(12) Patent Application Publication
(10) Pub. No.: US 2025/0358871 A1
(43) Pub. Date: Nov. 20, 2025

(54) METHODS, ARCHITECTURES, APPARATUSES, AND SYSTEMS FOR CONTROL PLANE FOR SIMPLIFIED ACCESS TRAFFIC, STEERING, SWITCHING, AND SPLITTING

(71) Applicant: InterDigital Patent Holdings, Inc., Wilmington, DE (US)

(72) Inventors: Xavier De Foy, Kirkland (CA); Taimoor Abbas, Sainte-Julie (CA); Rocco Di Girolamo, Laval (CA); Magurawalage Chathura Madhusanka Sarathchandra, London (GB); Guanzhou Wang, Brossard (CA); Zhibi Wang, Woodridge, IL (US)

(21) Appl. No.: 18/666,645

(22) Filed: May 16, 2024

(51) Int. Cl. H04W 76/10; H04W 40/02

(52) U.S. Cl. CPC H04W 76/10; H04W 40/02

(57) ABSTRACT

A control plane stream is provided between a wireless transmit/receive unit (WTRU) and a user plane function (UPF). For example, the WTRU establishes a protocol data unit (PDU) session with the UPF using a QUIC connection and determines to use this connection for the control plane stream. This determination may be based on a predefined trigger such as losing 3GPP access connectivity or receiving a network message. The control plane information, which may include data associated with establishing, modifying, or releasing the PDU session over the QUIC connection, is then communicated between the WTRU and the UPF. In some cases, a leg of the PDU session may be established over non-integrated non-3GPP access (NIN3A) via a QUIC proxy. Also, a multi-access (MA) PDU session may be established using multipath QUIC (MPQUIC) steering functionality via a QUIC proxy.

### TECHNICAL FIELD

The present disclosure is generally directed to the fields of communications, hardware, software and encoding, including, for example, to methods, architectures, apparatuses and systems related to a control plane for access traffic steering, switching, and splitting (ATSSS).

### BACKGROUND

The Multiplexed Application Substrate over QUIC Encryption (MASQUE) protocol enables multiple proxied flows in a hypertext transfer protocol (HTTP) connection, and requires the client to send an HTTP CONNECT request to initiate a service, which can be accepted or rejected by the proxy. ATSSS allows to steer, switch, or split Service Data Flows (SDF) between accesses, and relies on various steering functionalities and steering modes. The steering modes include the active-standby mode which switches traffic to another access when the active access becomes unavailable, and the smallest delay mode which switches traffic to the access with the smallest measured delay. The Simplified ATSSS, an evolution of ATSSS, is based on the multipath QUIC (MPQUIC) steering functionality and can maintain traffic over a Non-Integrated Non-3GPP Access (NIN3A) if the 3GPP access is lost, for a duration depending on a pre-determined time limit.

### SUMMARY

Simplified ATSSS is extended for control plane communication between a wireless transmit and/or receive unit (WTRU) and a network over a user plane. For example, control plane communication is provided between a WTRU and a network over NIN3A when no 3GPP access is available. Also, for example, a QUIC control plane stream is provided between the WTRU and a user plane function (UPF).

In certain representative embodiments, a WTRU establishes and uses a control plane stream over a QUIC connection. For example, a multi-access protocol data unit (MA PDU) session is provided over a 3GPP access. Also, for example, an MA PDU session is provided over a NIN3A access. Further, a PDU session is provided.

In certain representative embodiments, upon receiving a WTRU request, a network provides a PDU session. For example, the UPF is configured to accept a QUIC-based control plane (QUIC-CP) stream establishment request.

In certain representative embodiments, a WTRU provides a QUIC-CP stream with a UPF. For example, the WTRU or UPF triggers establishment of the QUIC-CP stream.

In certain representative embodiments, a WTRU exchanges control plane messages over a QUIC-CP stream with a network function (NF). For example, the WTRU exchanges control plane messages over the QUIC-CP stream with a session management function (SMF). Also, for example, control plane messages are exchanged via a UPF.

In certain representative embodiments, a method for setting up a control plane stream between a WTRU and a UPF is provided. For example, the WTRU establishes a PDU session with the UPF using a QUIC connection. The WTRU may decide to use this QUIC connection to provide the control plane stream with the UPF. Based on this decision, the WTRU may communicate control plane information over the control plane stream.

The PDU session with the UPF may be established by the WTRU sending a request to start the PDU session using a QUIC proxy. A leg of the PDU session may then be set up between the WTRU and the UPF over a NIN3A. The PDU session can also be established by the WTRU sending to the network a request to start a multi-access (MA) session using MPQUIC steering functionality. A leg of the MA PDU session may then be set up between the WTRU and the UPF over NIN3A. The PDU session can also be established by the WTRU sending a request indicating to exchange control plane information between the WTRU and the UPF over the control plane stream.

The decision to use the QUIC connection to communicate control plane information with the UPF may be made by detecting a predefined trigger to start communication of control plane information over the control plane stream. The predefined trigger can be one of many things such as losing 3GPP access connectivity, completing setting up the PDU session, modifying the PDU session, receiving a message from a network, deciding to stop using 3GPP access, deciding to not use 3GPP access, completing establishing the QUIC connection, a decision to change a NIN3A connectivity timer, or detecting a network load above a threshold.

The decision to use the QUIC connection to communicate control plane information with the UPF can also be made by receiving a message from the UPF instructing the WTRU to start communication of control plane information over the control plane stream. The control plane information may be transmitted from the WTRU to the UPF or from the UPF to the WTRU and includes data associated with at least one of establishing a new session over the QUIC connection, modifying the session over the QUIC connection, or releasing the session over the QUIC connection.

In certain representative embodiments, a WTRU for setting up a control plane stream between the WTRU and a UPF is provided. For example, the WTRU includes a processor to start a PDU session with the UPF using a QUIC connection, decide to use the QUIC connection to provide the control plane stream with the UPF, and based on this decision, communicate the UPF control plane information over the control plane stream.

The PDU session with the UPF may be established by the processor causing a request to be transmitted to start the session using a QUIC proxy, and then may set up a leg of the session between the WTRU and the UPF over NIN3A. The session can also be established by the processor causing a request to be transmitted to start a MA session with the UPF using MPQUIC steering functionality, and then setting up a leg of the MA session between the WTRU and the UPF over NIN3A. The session can also be established by the processor causing a request to be transmitted indicating to exchange control plane information between the WTRU and the UPF over the control plane stream.

The decision to use the QUIC connection to communicate control plane information with the UPF may be made by the processor detecting a predefined trigger to start communication of control plane information over the control plane stream. The predefined trigger can be one of many things such as losing 3GPP access connectivity, completing setting up the PDU session, modifying the PDU session, receiving a message from a network, deciding to stop using 3GPP access, deciding to not use 3GPP access, completing establishing a QUIC connection, a decision to change a NIN3A connectivity timer, or detecting a network load above a threshold.

The decision to use the QUIC connection to communicate control plane information with the UPF can also be made by the processor causing a message to be received from the UPF instructing the WTRU to start communication of control plane information over the QUIC connection. The control plane information may be transmitted from the WTRU to the UPF or from the UPF to the WTRU and may include data associated with at least one of establishing a new PDU session over the QUIC connection, modifying the PDU session over the QUIC connection, or releasing the PDU session over the QUIC connection.

In certain representative embodiments, a method for setting up a control plane stream between a WTRU and a UPF via an SMF is provided. For example, the method includes the UPF receiving data related to a QUIC connection to establish with the WTRU from the SMF. The data may indicate to use the control plane stream between the WTRU and the UPF over the QUIC connection. The UPF may then start a session with the WTRU using the QUIC connection, may decide to use the QUIC connection to communicate control plane information with the WTRU, and may, based on this decision, communicate with the WTRU the control plane information over the control plane stream.

The session with the WTRU may be established by the UPF receiving a request from the WTRU to start the session using a QUIC proxy, and then setting up a leg of the session between the WTRU and the UPF over NIN3A. The session can also be established by the UPF receiving a request from the WTRU to start a MA session with the UPF using MPQUIC steering functionality, and then setting up a leg of the MA session between the WTRU and the UPF over NIN3A. The session can also be established by the UPF receiving a request indicating to exchange control plane information between the WTRU and the UPF over the control plane stream.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit and/or receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of a WTRU with simultaneous 3GPP and non-3GPP access;

FIG. 3 is a diagram illustrating an example of a WTRU with simultaneous 3GPP and non-3GPP access with QUIC-CP capability;

FIG. 4A is first portion of a sequence diagram illustrating an example of establishment and usage of a NIN3A control plane on a 3GPP-access initiated MA PDU session;

FIG. 4B is second portion of a sequence diagram illustrating an example of establishment and usage of a NIN3A control plane on a 3GPP-access initiated MA PDU session;

FIG. 4C is third portion of a sequence diagram illustrating an example of establishment and usage of a NIN3A control plane on a 3GPP-access initiated MA PDU session;

FIG. 5 is a sequence diagram illustrating an example of establishment and usage of a NIN3A control plane on a NIN3A initiated MA PDU session;

FIG. 6A is a first portion of a sequence diagram illustrating an example of establishment and usage of a control plane over NIN3A in a simplified MA PDU session established over NIN3A;

FIG. 6B is a second portion of a sequence diagram illustrating an example of establishment and usage of a control plane over NIN3A in a simplified MA PDU session established over NIN3A;

FIG. 6C is a third portion of a sequence diagram illustrating an example of establishment and usage of a control plane over NIN3A in a simplified MA PDU session established over NIN3A;

FIG. 7 is a procedural diagram illustrating an example procedure for establishing a control plane stream between a WTRU and a UPF;

FIG. 8 is a procedural diagram illustrating an example procedure for a processor of a WTRU to establish a control plane stream between a WTRU and a UPF;

FIG. 9 is a procedural diagram illustrating an example procedure for establishing a control plane stream between a WTRU and a UPF via an SMF; and

FIG. 10 is a procedural diagram illustrating an example procedure for establishing a control plane stream including a QUIC-CP capable SMF.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

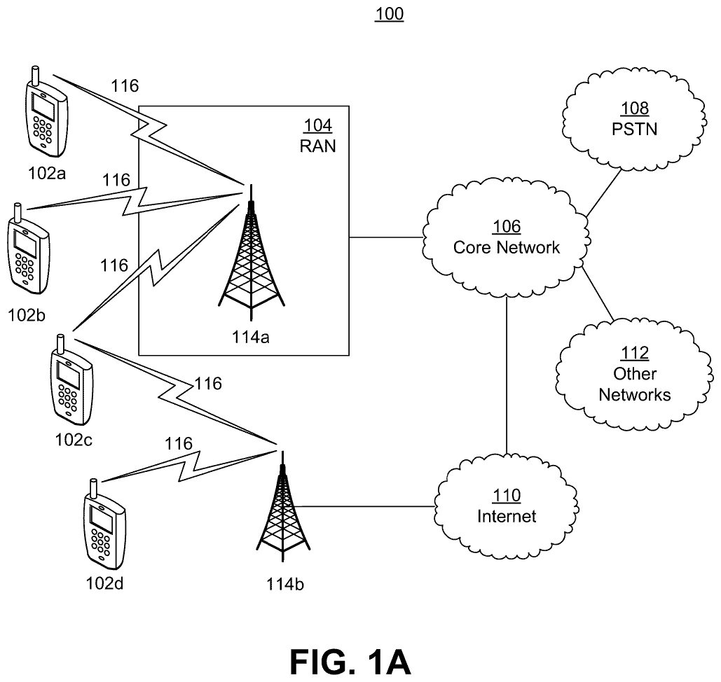

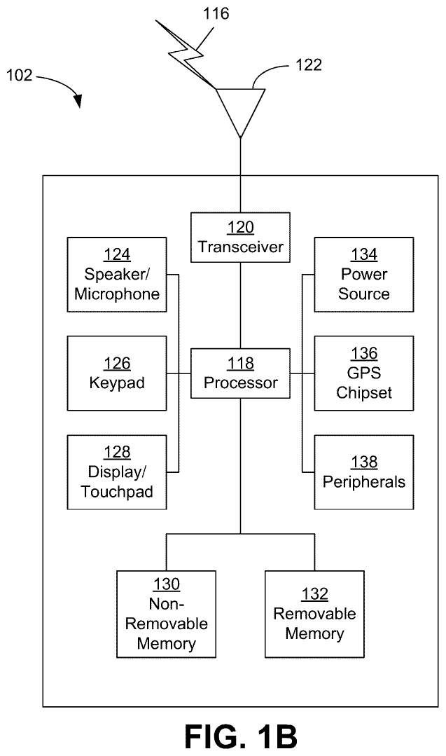

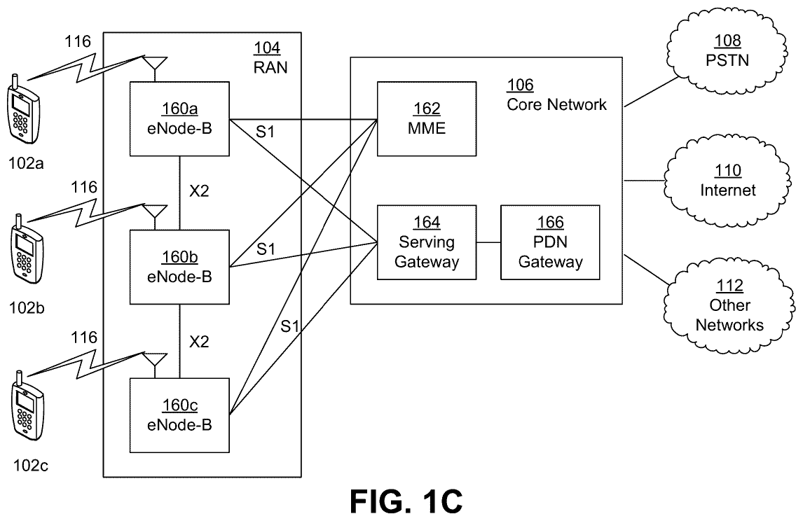

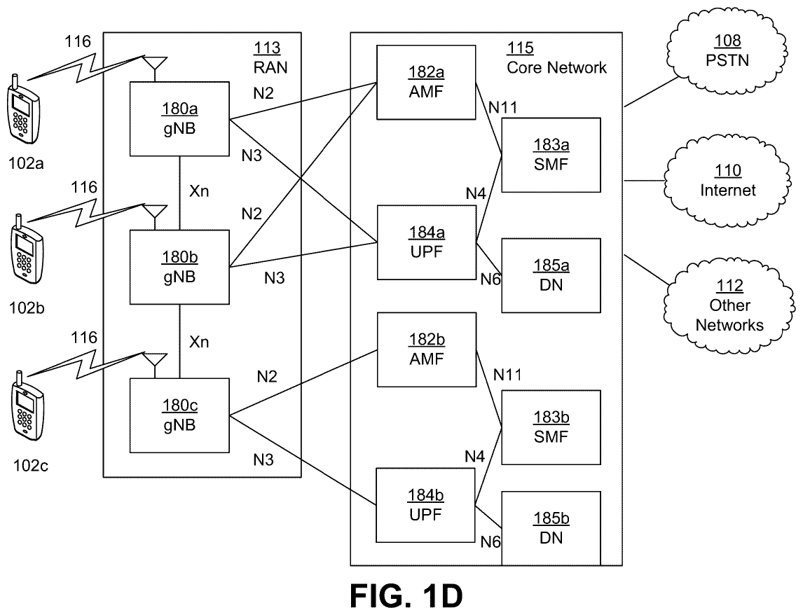

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, carrier sense multiple access with collision avoidance (CSMA/CA) may be implemented, for example in in 802.11 systems. For CSMA/CA, the STAs (e.g., every STA), including the AP, may sense the primary channel. If, for example, the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and a transmitting STA may transmit the data. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHZ, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if, for example, the AP, and other STAs in the BSS support 2 MHZ, 4 MHZ, 8 MHz, 16 MHZ, and/or other channel bandwidth operating modes. Carrier sensing and/or network allocation vector (NAV) settings may depend on the status of the primary channel. If, for example, the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANS (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The Multiplexed Application Substrate over QUIC Encryption (MASQUE) protocol enables configuring and running multiple proxied flows in an HTTP connection, e.g., using HTTP/3 over QUIC. The MASQUE services include the “CONNECT-UDP” service, which enables transporting UDP traffic between a client and a proxy, or between 2 proxies, “CONNECT-IP”, which enables transporting IP traffic, “CONNECT-ETHERNET”, which enables transporting Ethernet traffic, and “CONNECT”, which enables transporting WebSocket traffic (which is analogous to TCP traffic). For TCP traffic, “CONNECT” or a method derived from connect (e.g., a CONNECT-TCP method) may be used.

To initiate a MASQUE service, the client sends an HTTP CONNECT request to a proxy, e.g., an HTTP request including a method field set to “CONNECT,” a target field which indicates the endpoint of the connection, and a protocol field set to the actual MASQUE transport method used, such as “connect-udp,” “connect-ethernet” or “connect-ip.” The proxy sends an HTTP response to indicate that the service request is accepted or rejected. The MASQUE service includes forwarding the application payload transported over the MASQUE connection, towards an endpoint (e.g., UDP server, or endpoint over an Ethernet link or IP network). The application payload is transported in MASQUE connection over HTTP datagrams or over an HTTP stream. A MASQUE proxied connection can operate over a multipath (MPQUIC) connection. For example, the application payload transported in a MASQUE connection can be sent and received over different access networks by MPQUIC connection endpoints.

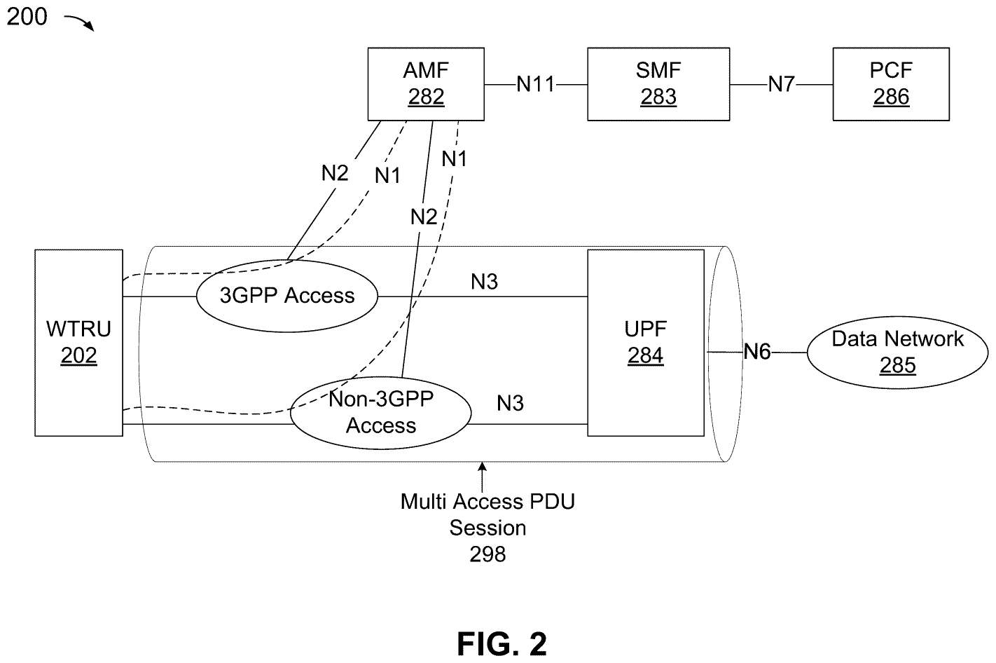

Utilizing ATSSS, most WTRUs are capable of both 3GPP access and non-3GPP access. This capability provides flexibility to the network operators in determining which access to use for a Service Data Flow (SDF). A multi-access PDU session (e.g., MA PDU session 298, see, FIG. 2) allows uplink and downlink traffic of a service data flow to be steered, switched, or split between accesses. An MA PDU session is a PDU session whose traffic can be sent over 3GPP access, or over non-3GPP access, or over both accesses.

FIG. 2 is a diagram illustrating an example of a system 200 including a WTRU 202 with simultaneous 3GPP and non-3GPP access. In certain representative embodiments, the system 200 includes at least one of the WTRU 202, an AMF 282, an SMF 283, a UPF 284, a data network 285, or a policy control function (PCF) 286. For example, an MA PDU session 298 is established between the WTRU 202 and at least one of the AMF 282 (e.g., via N1 and N2 interfaces), the SMF 283 (e.g., via N4 or N11 interfaces), the UPF 284 (e.g., via N3 interface), the data network 285 (e.g., via N6 interface), or the PCF 286 (e.g., via N7 interface). For example, the WTRU 202 may be connected to the AMF 282 via 3GPP access. Also, for example, the WTRU 202 may be connected to the AMF 282 via non-3GPP access.

The architecture shown in FIG. 2 allows traffic steering, traffic switching, and traffic splitting. For traffic steering, for example, an access network is selected for a new data flow and transfers the traffic of this data flow over the selected access network. For traffic switching, for example, an ongoing data flow is moved from one access network to another access network in a way that maintains the continuity of the data flow. For traffic splitting, for example, the traffic of a data flow can be split across multiple access networks. Some PDUs of the data flow are transmitted via one access and some other PDUs of the same data flow are transmitted via another access.

For example, the steering functionality, which resides in an ATSSS-capable WTRU and in the UPF 284, can steer, switch, and split the MA PDU session traffic across multiple accesses. Three steering functionalities have been standardized. Two high-layer steering functionalities, which operate above the IP layer, have been standardized: the MPTCP steering functionality applies to TCP traffic, and the MPQUIC steering functionality is applicable to UDP traffic. A low-layer steering functionality, which operates below the IP layer, has been standardized: the ATSSS Low-Layer functionality (ATSSS-LL) applies to Ethernet and IP traffic.

The steering mode determines how the traffic of the matching service data flow should be distributed across accesses. Only one steering mode can be used for an SDF.

The active-standby steering mode steers traffic on one access (e.g., the active access) when this access is available, and switches the traffic to the other access (e.g., the standby access) when the active access becomes unavailable.

The smallest delay steering mode steers traffic to the access that is determined to have the smallest Round-Trip Time (RTT). WTRU 202 and UPF 284 measure the RTT in order to determine which access has the lowest RTT. It can only be used for a non-GBR SDF.

The load balancing steering mode splits traffic across both accesses according to a configurable percentage. When an autonomous load-balance indicator is provided by the network, the WTRU 202 autonomously determines the percentages for traffic splitting. Load-balancing is only applicable to non-GBR SDF.

The priority based steering mode steers all the traffic matching a policy and charging control (PCC) rule to the high priority access, until this access is determined to be congested. In this case, the traffic is sent also to the low priority access, i.e., the traffic is split over the two accesses. It can only be used for the non-GBR SDF.

The redundant steering mode (RSM) allows a WTRU 202 and UPF 284 to duplicate traffic over both access legs of an MA PDU session 298.

Additional configurations may be provided by the network to modify the steering mode behavior on the WTRU 202 and UPF 284: a WTRU-assistance indicator enables the WTRU 202 to decide how to distribute UL traffic in some implementations (e.g., when in low battery mode); a threshold value (e.g., RTT or packet loss rate) enables WTRU 202 and UPF 284 to reduce usage on an access when a threshold value is reach on this access; for MPQUIC steering functionality, a configuration item enables transporting a stream or datagram without reordering, or datagram with reordering.

A performance management function (PMF) protocol is used between WTRU 202 and UPF 284 to make measurements for switching mode decisions (e.g., RTT, access availability report, packet loss rate, and the like).

The selection of a steering functionality and steering mode for an SDF in an MA PDU session 298 is performed by an SMF 283, based on MA PDU session control information present in a PCC rule. MA PDU session control information include a steering mode and functionality, as well as additional configuration parameters, some of which were described herein.

Simplified ATSSS is an evolution of ATSSS, where one leg of an MA PDU session 298 is over a 3GPP access, and the other leg is over a Non-Integrated Non-3GPP Access (NIN3A). For simplicity, we may use the term “PDU session leg” herein, to designate the control plane and/or user plane portion of a PDU session over one access (e.g., this can be one leg of an MA PDU session, or the entirety of a single access PDU session). In this context, the MA PDU session 298 can be called a simplified MA PDU session 298. A mechanism for simplified ATSSS is based on the MPQUIC steering mode, where the 3GPP access leg is established first. In this case, the MPQUIC connection is established over the 3GPP access, and the WTRU 202 then establishes a second path on the same MPQUIC connection, over NIN3A, towards the external IP address of the UPF 284. The WTRU 202 obtains the external IP address of the UPF 284 (e.g., accessible over NIN3A) from the SMF 283 over the 3GPP access (e.g., in the PDU session establishment and/or modification response). No extra authentication is required for the second leg, since material (e.g., security material such as cryptographic keys) for the MPQUIC path over NIN3A was obtained over the initial MPQUIC connection establishment, over the 3GPP access.

Once a simplified MA PDU session 298 is established, if the WTRU 202 loses its 3GPP access, the WTRU 202 may continue sending and receiving traffic over the NIN3A leg of the simplified MA PDU session 298 (which is sent and received over the second leg of the MPQUIC connection with the UPF 284). The Simplified ATSSS can maintain traffic over NIN3A if, for example, the 3GPP access is lost for a duration depending on a pre-determined time limit. Herein, a NIN3A connectivity timer is, for example, a timer that measures and signals the end of this time limit. The NIN3A connectivity timer can be configured for an MA PDU session 298. Once the 3GPP access is lost, the NIN3A connectivity timer is started, and a NIN3A leg may be maintained until the timer is expired.

Additionally, in some implementations, it may be possible to initiate a simplified MA PDU session 298 over the NIN3A leg. The WTRU 202 detects the UPF 284, e.g., using a DNS-based method similar to the N3IWF discovery method. The WTRU 202 then initiates a QUIC connection to the UPF 284. The WTRU 202 then initiates an authentication procedure over the QUIC connection. At this point, in this example, the WTRU 202 is authenticated by the network, and the QUIC connection is available to exchange messages between the WTRU 202 and the UPF 284.

The architecture of FIG. 2 includes several shortcomings. In a first use case, a simplified ATSSS MA PDU session 298 is established over a 3GPP access. For example, the simplified ATSSS MA PDU session 298 uses the MPQUIC steering function. After the MA PDU session 298 is established, the WTRU 202 establishes the NIN3A leg, by establishing a second path of an MPQUIC connection with the UPF 284.

However, if, for example, in the first use case, the 3GPP access is lost, there is no mechanism to exchange control plane information between the WTRU 202 and the network. For example, even when the NIN3A connectivity timer is not set prior to 3GPP access loss (e.g., at MA PDU session 298 establishment time), control plane information between the WTRU 202 and the network is exchanged. Also, for example, the NIN3A connectivity timer cannot be modified after 3GPP access loss. More generally, for example, after 3GPP access loss, there is no mechanism to update other aspects of the simplified MA PDU session 298, such as adding and/or removing service data flows.

Additionally, in the first use case, there is no mechanism to update the NIN3A connectivity timer after the initial establishment of the MA PDU session 298. Therefore, once the 3GPP access is lost, the NIN3A leg can be maintained for the duration of the NIN3A connectivity timer, which cannot be updated based on context.

In a second use case, a simplified ATSSS MA PDU session 298 is established over a NIN3A access. For example, the WTRU 202 establishes a QUIC connection with the UPF 284 and provides authentication information over this connection. The second use case may occur, for example, if the WTRU 202 is at a location where there is no 3GPP access, or if it is desired for the WTRU 202 to use a single NIN3A leg and obtain access to operator services at the UPF 284, such as parental control or firewall services. In this second use case as well, there is no mechanism to exchange control plane information between the WTRU 202 and the network. For example, there is no mechanism for the WTRU 202 to provide a PDU session ID to the network, which could later be used to establish the second leg of the MA PDU session 298 over the 3GPP access.

In a third use case, a PDU session is transported over a QUIC connection between WTRU 202 and UPF 284 (e.g., an MA PDU session 298 using the MPQUIC steering mode). However, in the third use case, there is no mechanism to leverage the WTRU-UPF QUIC connection to exchange control plane information, which can contribute to reduce the AMF 282 computing load.

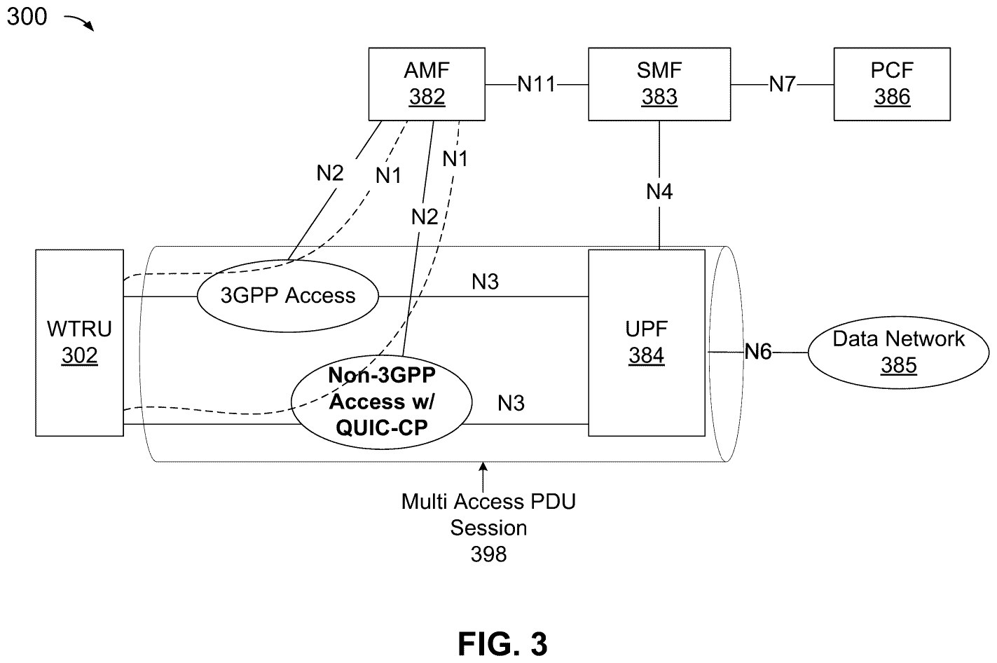

In certain representative embodiments, as shown in FIG. 3, a system 300 is provided with one or more QUIC-CP capabilities. The system 300 overcomes at least the shortcomings in the architecture of FIG. 2 described above. Among other features, the system 300 provides a mechanism to exchange control plane information, for example, when 3GPP access is lost or when the AMF is overloaded. Also, the system 300 provides a mechanism to update the NIN3A connectivity timer, for example, when 3GPP access is lost. Further, when a simplified ATSSS MA PDU session is established over a NIN3A access, the system 300 provides a mechanism to exchange control plane information, for example. Still further, when a PDU session is transported over a QUIC connection, the system 300 leverages a WTRU-UPF QUIC connection to exchange control plane information. Additional features and advantages are provided herein.

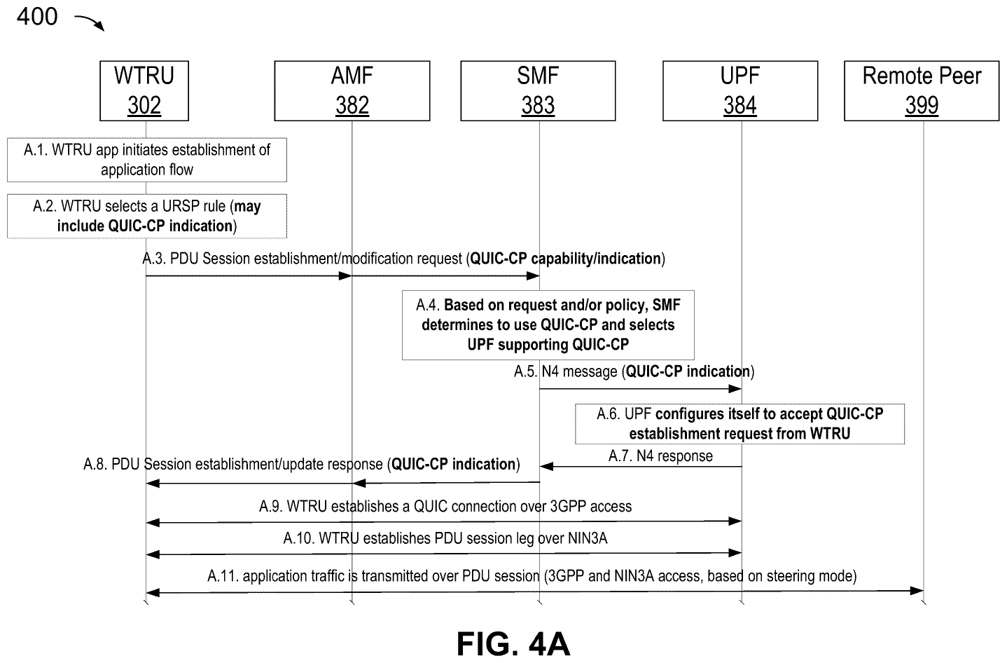

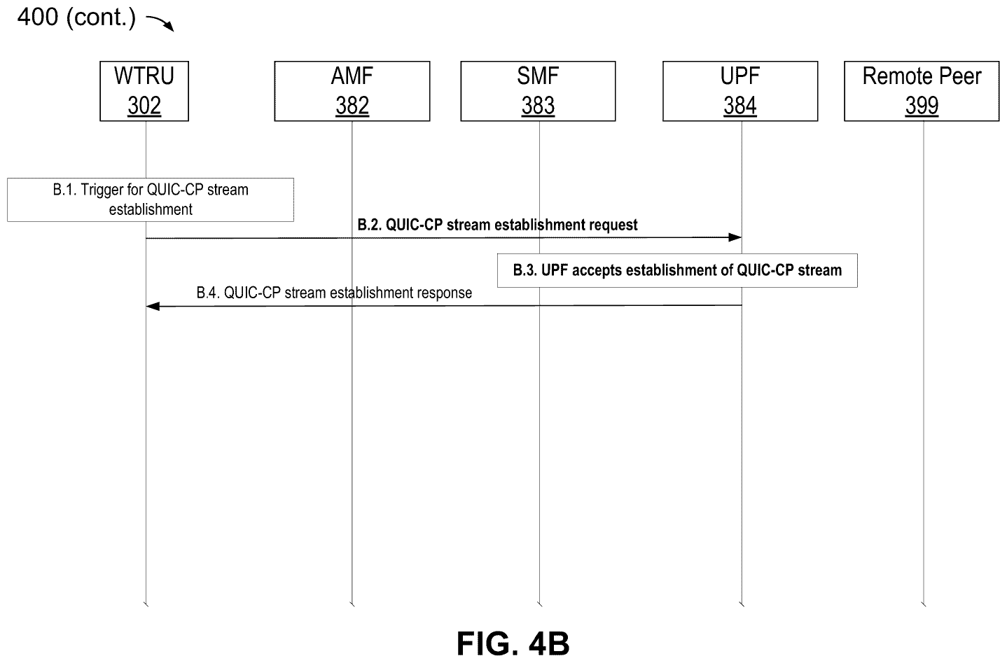

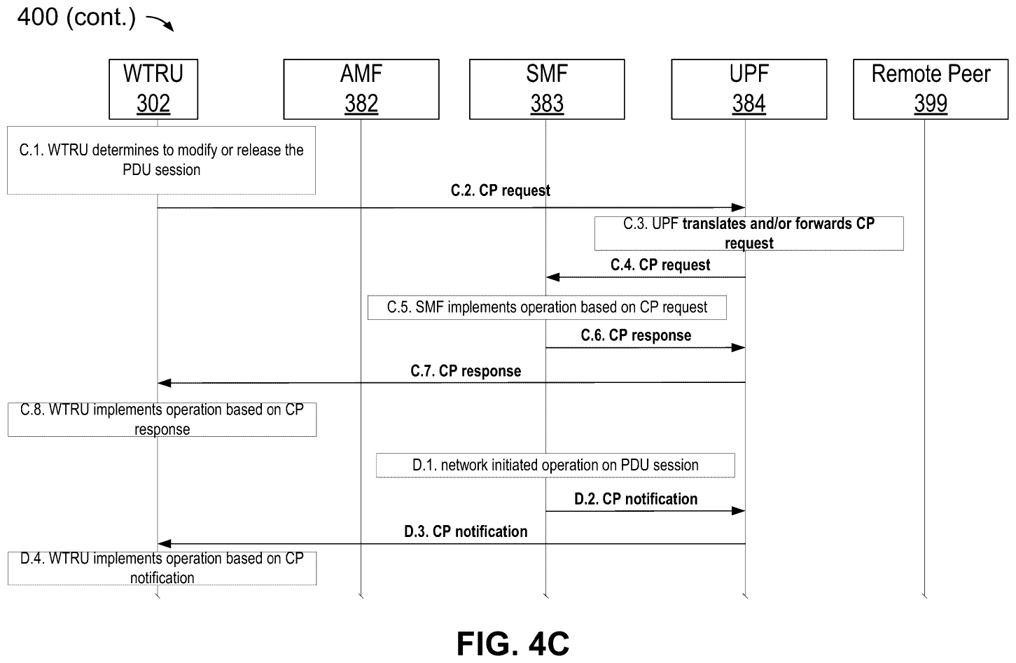

In certain representative embodiments, QUIC-CP is provided. Examples of procedures for providing QUIC-CP are shown and described herein in FIGS. 4A-4C, 5, 6A-6C, and 7-10 and related descriptions. Details are provided herein in various use cases, scenarios, systems, methods, streams, sessions, examples, indications, messages, operations, and the like.

In certain representative embodiments, QUIC-CP is provided for a WTRU 302. One or more steps are performed on the WTRU 302. For example, a process for QUIC-CP for a WTRU 302 includes at least one of QUIC-CP establishing, QUIC-CP triggering, QUIC-CP requesting, QUIC-CP responding, CP messaging, or CP responding.

For the QUIC-CP establishing, for example, the WTRU 302 establishes a QUIC connection to a UPF 384. For example, the WTRU 302 requests establishment of a PDU session (e.g., possibly including a QUIC-CP indication). Also, for example, the PDU session is established over a QUIC connection (e.g., an MA PDU session 398 using the MPQUIC steering functionality, or a regular PDU session using a QUIC proxy). Further, for example, the WTRU 302 establishes a QUIC connection to UPF 384 over NIN3A.

For the QUIC-CP triggering, for example, the WTRU 302 determines to use QUIC-CP based on a trigger (e.g., loss of 3GPP access). In some implementations, a network receives a trigger and initiates the QUIC-CP stream.

For the QUIC-CP requesting, for example, the WTRU 302 sends a QUIC-CP establishment request to the UPF 384 over the QUIC connection (e.g., an HTTP CONNECT request including a QUIC-CP indication). In some implementations, the UPF 384 may send the initial message to establish the QUIC-CP stream, in which case QUIC-CP requesting step and the QUIC-CP responding step would be reversed between send and receive.

For the QUIC-CP responding, for example, the WTRU 302 receives a QUIC-CP establishment response indicating success.

For the CP messaging, for example, the WTRU 302 sends a control plane message for establishing, modifying, and/or releasing a PDU session over the QUIC-CP stream (e.g., a request to set or update a NIN3A timer, a PDU session modification or establishment request, or the like). Another example of a CP message includes a message from SMF 383 to WTRU 302. While many examples herein are described with respect to the WTRU 302 request as a primary example (e.g., in the CP messaging and the CP responding), this is not intended to be limiting.

For the CP responding, for example, the WTRU 302 receives a control plane message response (e.g., a response to the CP messaging). For example, the WTRU 302 performs one or more operations corresponding to the control plane message (e.g., update local timer, add rules, or the like).

In certain representative embodiments, QUIC-CP is provided for an SMF 383. One or more steps are performed on the SMF 383. For example, a process for QUIC-CP for an SMF 383 includes at least one of request receiving, QUIC-CP determining, message sending, message receiving, operating, or QUIC-CP responding.

For the request receiving, for example, the SMF 383 receives a PDU session establishment and/or modification request, which may include a QUIC-CP capability or indication.

For the QUIC-CP determining, for example, based on the QUIC-CP capability and/or indication from the request and/or from a policy rule, the SMF 383 determines to enable QUIC-CP for this PDU session.

For the message sending, for example, the SMF 383 sends an N4 message to the UPF 384, including a QUIC-CP indication.

For the message receiving, for example, the SMF 383 receives an N4 message from the UPF 384, including a QUIC-CP request message from the WTRU 302.

For the operating, for example, the SMF 383 implements an operation indicated by the QUIC-CP request message (e.g., PDU session modification, NIN3A connectivity timer update, or the like).

For the QUIC-responding, for example, the SMF 383 sends a QUIC-CP response message in an N4 message to the UPF 384.

In certain representative embodiments, QUIC-CP is provided for a UPF 384. One or more steps are performed on the UPF 384. For example, a process for QUIC-CP for a UPF 384 includes at least one of N4 message receiving, proxying, QUIC message receiving, QUIC message sending, QUIC-CP message receiving, CP request messaging, CP response messaging, or CP response message sending.

For the N4 message receiving, for example, the UPF 384 receives an N4 message from the SMF 383, including a QUIC-CP indication.

For the proxying, for example, the UPF 384 creates a QUIC proxy (or select an existing QUIC proxy).

For the QUIC message receiving, for example, the UPF 384 receives a QUIC message from the WTRU 302, requesting the establishment of a QUIC-CP stream.

For the QUIC message sending, for example, the UPF 384 sends a QUIC message to the WTRU 302, indicating the success of the establishment of a QUIC-CP stream.

For the QUIC-CP message receiving, for example, the UPF 384 receives a QUIC-CP message from the WTRU 302 over the QUIC-CP stream, including a control plane request message.

For the CP request messaging, for example, the UPF 384 sends the control plane request message to the SMF 383, over N4.

For the CP response messaging, for example, the UPF 384 receives a control plane response message from the SMF 383, over N4.

For the CP response message sending, for example, the UPF 384 sends the control plane response message to the WTRU 302, over the QUIC-CP stream.

In certain representative embodiments, a mechanism is provided to exchange control plane information over a QUIC-based user plane connection. For example, a WTRU 302 requests a control plane stream on the QUIC connection with a UPF 384. Once the control plane stream is established, the UPF 384 may relay control messages between the WTRU 302 and SMF 383, using the control plane stream between WTRU 302 and UPF 384, and using the enhanced N4 session between UPF 384 and SMF 383, for example.

The control plane over the WTRU-UPF QUIC connection is designated herein as QUIC-CP. For example, the QUIC-CP stream may include at least one of a QUIC stream, datagrams associated with a QUIC stream, datagrams associated with a context ID, or more generally a channel of communication within the WTRU-UPF QUIC connection. Herein an example of a control plane stream is described. For example, the control plane stream may be a QUIC stream over which the WTRU 302 creates a proxied connection to the SMF 383 using CONNECT. QUIC-CP messages (also referred to herein as control plane messages or CP messages) may be sent over the QUIC-CP stream. These control plane messages may use the format of existing NAS messages (e.g., using the message format used over the network slice management function (Nsmf) interface), or other message formats such as JavaScript object notation (JSON) or concise binary object representation (CBOR).

In certain representative embodiments, a node (e.g., WTRU 302, SMF 383 and/or UPF 384) exposes a QUIC-CP capability attribute. For example, the QUIC-CP capability attribute may indicate that the node supports the QUIC-CP mechanisms and procedures described herein. A node (e.g., WTRU 302 or SMF 383) may send a QUIC-CP indication, which indicates that QUIC-CP may or should be used. A QUIC-CP indication may in some implementations include additional parameters, such as a list of the operations available on the QUIC-CP stream.

A QUIC-CP stream provides benefits related to control and load reduction. For example, the QUIC-CP stream provides control of a simplified MA PDU session 398 when the 3GPP access is not available any more or when the 3GPP access is not yet available. Also, for example, the QUIC-CP stream provides control plane interactions without creating load on the operator's core network control plane (e.g., without using computing resources on the AMF 382). More generally, QUIC-CP can be used to transfer some of the control plane load onto the user plane.

As noted in detail herein, the non-3GPP access includes QUIC-CP functions. Further, for example, additional QUIC-CP functions are described herein with respect to at least one of the WTRU 302, the AMF 382, the SMF 383, the UPF 384, and a remote peer 399.

Exemplary scenarios are provided including QUIC-CP capabilities and indications. Three exemplary scenarios are provided herein as context.

In at least any of the three scenarios, the AMF 382 may select the SMF 383. For example, the selection of the SMF 383 by the AMF 382 is based on the QUIC-CP capability and/or indication from the WTRU 302. Also, for example, the selection of the SMF 383 by the AMF 382 is based on the QUIC-CP capability of the SMF 383 (e.g., obtained from network configuration and/or network repository function (NRF)). In at least any of the three scenarios, the SMF 383 may select the UPF 384. For example, the selection of the UPF 384 by the SMF 383 is based on the QUIC-CP capability and/or indication from the WTRU 302. Also, for example, the selection of the UPF 384 by the SMF 383 is based on the QUIC-CP capability of the UPF 384 (e.g., obtained from network configuration and/or NRF).

In scenario #1, for example, the WTRU 302 requests the establishment or modification of an MA PDU session 398 with the network over a 3GPP access. The WTRU 302 may include a QUIC-CP capability (or indication) in the PDU session establishment or modification request. The AMF 382 may select the SMF 383. The SMF 383 may determine to enable QUIC-CP for this MA PDU session 398, based on QUIC-CP capability and/or indication in the request and/or in a PCC rule. The SMF 383 may select the UPF 384. The SMF 383 may send an N4 message to the UPF 384, including a QUIC-CP indication (and a NIN3A indication). The UPF 384, based on the N4 message, may create a QUIC proxy instance (or selects an existing QUIC proxy instance) on the UPF 384. The UPF 384 may send QUIC proxy information (e.g., IP address and port, and external UPF IP address) to the SMF 383, and the SMF 383 may provide the QUIC proxy information to the WTRU 302 in the PDU session establishment and/or modification response. Using this QUIC proxy information, the WTRU 302 may establish an MPQUIC connection to the UPF 384 over the 3GPP access. The WTRU 302 may then establish a second leg of the MPQUIC connection to the UPF 384 over NIN3A (e.g., using the external UPF IP address). At this point, in this example, the simplified ATSSS MA PDU session 398 is established, with a leg over 3GPP access and a leg over NIN3A. The application traffic may be transported over one or both legs of the WTRU-UPF MPQUIC connection.

In scenario #2, for example, a (e.g., QUIC-CP capable and NIN3A capable) UPF 384 is made available by a network operator for discovery by the WTRU 302. Before making a UPF 384 available for discovery, a QUIC proxy (e.g., MPQUIC MASQUE proxy) may be created on the UPF 384 and accepts connection attempts by WTRUs. The WTRU 302 may discover a UPF 384 (e.g., using a DNS-based procedure similar to the N3IWF gateway discovery procedure), connect to the UPF 384 over NIN3A (e.g., using a QUIC connection), and authenticate with the network (e.g., using an authentication, authorization, and accounting (AAA) procedure over the QUIC connection). At this point, in this example, the WTRU 302 has a QUIC connection to the UPF 384. The QUIC connection may be multi-path capable for future use with the 3GPP access. The application traffic may be transported over the WTRU-UPF QUIC connection. This QUIC connection may be QUIC-CP enabled, e.g., the mechanisms and procedures defined herein may be used to exchange QUIC-CP messages over the QUIC connection between WTRU 302 and UPF 384.

In scenario #3, for example, the WTRU 302 requests the establishment or modification of a PDU session with the network, over a 3GPP or non-3GPP access. The WTRU 302 may include a QUIC-CP capability or indication in the PDU session establishment or modification of the PDU session. The AMF 382 may select the SMF 383. The SMF 383 may determine to use QUIC-CP based on the QUIC-CP capability and/or indication from the WTRU 302 and/or in a PCC rule. The SMF 383 may select a QUIC-CP capable UPF 384. The SMF 383 may send an N4 message to the UPF 384, including a QUIC-CP indication. The UPF 384, based on the N4 message, may create an QUIC proxy instance (or selects an existing QUIC proxy instance) on the UPF 384. The UPF 384 may send QUIC proxy information (e.g., IP address and port) to the SMF 383, and the SMF 383 may provide the QUIC proxy information to the WTRU 302 in the PDU session establishment and/or modification response. Using this QUIC proxy information, the WTRU 302 may establish a QUIC connection to the UPF 384 over the 3GPP access. At this point, in this example, a PDU session is established, where user plane traffic may be transported over the QUIC connection between WTRU 302 and UPF 384. This PDU session may be QUIC-CP enabled, e.g., the mechanisms and procedures defined herein can be used to exchange QUIC-CP messages over the QUIC connection between WTRU 302 and UPF 384, bypassing the AMF 382 in the core network.

In certain representative embodiments, a decision to establish a QUIC-CP stream is provided. For example, in at least any of the three scenarios scenario, the WTRU 302 may determine to establish a QUIC-CP stream based on a trigger. The trigger may include, at the WTRU 302, at least one of losing 3GPP connectivity, completing setting up the PDU session, receiving a message from the network, deciding to stop using (or not using) the 3GPP access, completing establishing a QUIC connection, a decision to change the NIN3A connectivity timer, or the like.

For example, when the WTRU 302 loses 3GPP access connectivity, QUIC-CP is made available to continue control aspects of the PDU session.

For example, when the WTRU 302 completed setting up the PDU session, QUIC-CP is made available for future use.

For example, when the WTRU 302 received a message from the network, the WTRU 302 requests to use QUIC-CP (e.g., to reduce AMF 382 network load from CP messages).

For example, when the WTRU 302 decided to stop using (or not using) the 3GPP access for an MA PDU session 398 (e.g., for cost or energy consumption reason), the WTRU 302 determines to establish a QUIC-CP stream.

For example, when the WTRU 302 completed establishing a QUIC connection to the UPF 384 (e.g., in scenario #2, where QUIC-CP can be used to establish a PDU session over the QUIC connection over NIN3A), the WTRU 302 determines to establish a QUIC-CP stream.

For example, when the WTRU 302 wishes to change the NIN3A connectivity timer (e.g., based on new context from the application or current WTRU 302 location), the WTRU 302 determines to establish a QUIC-CP stream.

In some implementations, the network may determine to establish a QUIC-CP stream based on a trigger. The trigger may include at least one of the WTRU 302 losing 3GPP access connectivity, completing the PDU session establishment or modification, establishing the QUIC path over NIN3A, detecting the network load above a threshold (e.g., the AMF 382 may send an overload notification to the SMF 383, and the SMF 383 may send an overload notification or QUIC-CP indication to the UPF 384), the network determining that the NIN3A connectivity timer value should be changed (e.g., based on network operator's input), or the like.

In certain representative embodiments, a QUIC-CP stream is established. For example, once the WTRU 302 (or UPF 384) determined to establish a QUIC-CP stream, the WTRU 302 (or UPF 384) may send a message to the UPF 384 (or WTRU 302), over the WTRU-UPF QUIC connection, to establish a communication channel that will be used as QUIC-CP.

In a first exemplary method, the WTRU 302 may create a (e.g., bidirectional) QUIC stream (e.g., reserves a new stream ID and sends a STREAM frame including the stream ID and an initial message) and may send over this new QUIC stream a CONNECT request (e.g., connect-ip or connect-udp), including a fully qualified domain name (FQDN) that identifies the SMF 383 (e.g., a generic SMF FQDN provided by the operator through WTRU 302 configuration, such as smf.<operator>.com). In this first exemplary method, the QUIC-CP stream is therefore a UDP or IP tunnel over HTTP over the QUIC connection (e.g., as described in RFC 9298 or RFC 9484). The UPF 384 can, in this case, efficiently forward UDP or IP messages between the SMF 383 and the WTRU 302, over this tunnel.

In a second exemplary method, the WTRU 302 creates a bidirectional QUIC stream and sends a “QUIC-CP establishment request” message to the UPF 384 over this new stream. To simplify the identification of the QUIC-CP stream, a predefined, fixed stream ID such as 0 may be reserved for use for QUIC-CP. The UPF 384 may send an “establishment QUIC-CP response” message indicating the success or failure of the operation.

Furthermore, the network (e.g., UPF 384) may initiate the establishment of a QUIC-CP stream. For example, the UPF 384 may create a QUIC stream on the QUIC connection and send a QUIC-CP establishment request message to the WTRU 302. The WTRU 302 may accept (e.g., based on the WTRU 302 QUIC-CP capability) and may send a response to the UPF 384 on the QUIC stream.

Other methods may be used by the WTRU 302 or UPF 384 to send QUIC-CP messages (e.g., send QUIC-CP messages in HTTP CAPSULE messages).

In certain representative embodiments, an N4 session is enhanced for QUIC-CP. For example, the N4 session between UPF 384 and SMF 383 is enhanced to relay QUIC-CP messages between WTRU 302 and SMF 383 through UPF 384. A QUIC-CP capable SMF 383 and a QUIC-CP capable UPF 384 may support a new “CP over N4” message (e.g., an N4 message). The “CP over N4” message may include a control plane message and includes the identification of the N4 session (e.g., the identification of the PDU session) that this control plane message refers to.

The CP-over-N4 message may be used in some implementations directly between UPF 384 and SMF 383, without forwarding its content to or from the WTRU 302. For example, if the WTRU 302 disconnect its MPQUIC connection from the UPF 384 over NIN3A, in the case where there is no 3GPP access leg (e.g., the NIN3A leg was the last active leg of the simplified MA PDU session 398), the UPF 384 may send a “pdu-session-release-request” message over “CP over N4” to the SMF 383, to trigger the release of the PDU session.

The UPF 384 can forward QUIC-CP control messages between the WTRU 302 (e.g., over the QUIC-CP stream) and SMF 383 (e.g., in CP-over-N4 messages). Upon receiving a CP-over-N4 message, the SMF 383 may identify the associated PDU session, and then may execute the operation associated with the control plane message. Upon receiving a CP-over-N4 message, the UPF 384 may identify the associated PDU session, then may identify the QUIC connection and/or QUIC streams within the QUIC connection, which are associated with this PDU session, and then may forward the control plane message over the QUIC-CP stream associated with the PDU session. If the QUIC-CP stream serves multiple PDU sessions, the UPF 384 may include an ID (e.g., PDU session ID) in the header of the QUIC-CP message. Upon receiving a QUIC-CP message, the WTRU 302 may identify the associated PDU session based on the QUIC connection, QUIC-CP stream and/or QUIC-CP message header. In case of error (e.g., the PDU session ID in the QUIC-CP message header does not match a valid PDU session), the node (e.g., WTRU 302 or UPF 384) that detects the error can send an error message over QUIC-CP, indicating the nature of the error. Some errors may result in closing the QUIC-CP stream.

In certain representative embodiments, control plane messages and operations are supported over QUIC-CP. For example, the WTRU 302 sends control plane messages (e.g., request messages) over the QUIC-CP stream towards the SMF 383 through the UPF 384. The SMF 383 may send control plane messages (e.g., response messages or notification messages) to the UPF 384 over N4, which the UPF 384 may forward towards the WTRU 302 over the QUIC-CP stream. In some implementations, the UPF 384 may also generate and send control plane messages to the WTRU 302 over QUIC-CP or to the SMF 383 over N4. WTRU 302, SMF 383 and/or UPF 384 may receive control plane messages. If the control plane messages are not in an Nsmf format, the SMF 383 may be enhanced to process control messages in this format, or alternatively the SMF 383 or UPF 384 may perform a message translation between Nsmf format and the QUIC-CP control plane message format.

The WTRU 302 can send or receive a range of control plane messages over QUIC-CP, including messages similar to existing (e.g., NAS) messages (e.g., PDU session establishment and modification requests), as well as new messages (e.g., a message to set a NIN3A parameter such as the NIN3A connectivity timer). Some control plane messages may in some implementations be simplified compared to their NAS equivalent if any (e.g., a QUIC-CP PDU session modification message may be a simplified version of the NAS PDU session modification message, e.g., it may include a subset of the information elements (IEs) of the NAS message). Some control plane messages may be sent by the WTRU 302 and trigger a response from the SMF 383. The SMF 383 may send some control messages through UPF 384 (e.g., a notification) to the WTRU 302. QUIC-CP control plane messages may include a message type IE, which indicates to the receiver (e.g., WTRU 302 or UPF 384 or SMF 383) how to process the message. QUIC-CP control plane messages may include additional parameters specific to the message type. The following examples describe the usage of some control message type (and related parameters).

set-nin3a-timer-request (e.g., timer value): upon reception, the receiver (which may be the SMF 383 or UPF 384 depending on the system) may set the NIN3A connectivity timer to the provided value (e.g., an integer value in seconds or an indefinite value if 0). The SMF 383 or UPF 384 may adjust the timer value, e.g., to keep it within a range of valid values configured by the network operator. The SMF 383 or UPF 384 may send a response “set-nin3a-timer-response” (e.g., timer value) to indicate the actual timer value used. The WTRU 302 may set a local NIN3A timer using the value received in the response. In some implementations, the fact that the WTRU establishes a QUIC-CP stream may be interpreted by the network as an indication that the NIN3A connectivity timer should be set to a value (e.g., indefinite value). For example, when a QUIC-CP stream is established, the UPF notifies the SMF of the QUIC-CP stream establishment, and the SMF sets the NIN3A connectivity value to, e.g., 0.

pdu-session-modification-request (e.g., traffic filter, traffic filter operation, requested QoS, or the like): this control plane message may be a simplified version of the NAS PDU session modification, e.g., to request QoS for a specific flow. Alternatively, this message may include all or most IEs present in PDU session modification request messages sent over NAS. In the exemplary case where the WTRU 302 requests QoS for a specific flow, upon reception, the SMF 383 may modify the PDU session to create a new QoS flow (e.g., if required) and associate the traffic flow to it. If the 3GPP access is available (e.g., in scenario #3), the SMF 383 may configure the RAN. The SMF 383 may configure the UPF 384 with updated N4 rules. The SMF 383 may reply to the WTRU 302, with a pdu-session-modification-response through the UPF 384.

pdu-session-release-request: this control plane message may be sent by the WTRU 302 to release the PDU session. In some systems, this control plane message may be sent by the UPF 384 to SMF 383, when the WTRU 302 disconnects from the UPF 384 over NIN3A (e.g., if this is the last active leg of the MA PDU session 398). Alternatively, in this case, the UPF 384 may send a “QUIC connection disconnected” control plane message to the SMF 383, including the PDU session ID, to indicate that the NIN3A leg of the PDU session was released.

pdu-session-establishment-request: this control plane message may be sent by the WTRU 302 in scenario #2, to enable using the MPQUIC connection to UPF 384 over NIN3A to be used for PDU session user plane traffic. Upon reception of this request, the SMF 383 may set up a PDU session. Later, when the WTRU 302 recovers its 3GPP access, the WTRU 302 may send a PDU session modification over the 3GPP access, including the same PDU session ID, to use the PDU session as a simplified MA PDU session 398 over two legs.

Other control plane messages for other NFs are provided, for example. In some implementations, the control plane messages can be forwarded by the UPF 384 and SMF 383, between WTRU 302 and NF. The SMF 383 may relay control plane messages to their destination NF, e.g., AMF 382, PCF 386, network exposure function (NEF), application function (AF), or the like, based on a “destination” IE present in the CP message.

In some implementations, the control plane messages can be forwarded by the UPF 384 between WTRU 302 and NF. For example, the WTRU 302 may create a different QUIC-CP stream to communicate specifically with an NF (e.g., by sending an HTTP CONNECT with target pcf.<operator>.com), and in this case the UPF 384 forwards CP messages on this QUIC-CP stream between the WTRU 302 and the NF.

In certain representative embodiments, the NIN3A connectivity timer is updated over N2. In some implementations, it is possible to set the NIN3A connectivity timer using the existing PDU session establishment and/or modification procedures. Control of the NIN3A connectivity timer may be done proactively when the context changes, prior to losing 3GPP access. In some embodiments, a new “connectivity timer” information element is added in the NAS PDU session establishment and modification request and response messages (e.g., sent over the N2 interface). For example, the timer is set to 1 minute by default. The application may start a task that requires 10 minutes to complete. The WTRU 302 may send a PDU session modification request message (e.g., over N2) including the new NIN3A connectivity timer value. The SMF 383 may configure the new timer value in the UPF 384 (e.g., using an N4 message to set the NIN3A connectivity timer) and may reply to the WTRU 302 with the agreed timer value. The WTRU 302 may update the local value of the NIN3A connectivity timer to the agreed timer value.

In certain representative embodiments, establishment and usage of QUIC-CP on a 3GPP access-initiated simplified MA PDU session are provided. For example, FIGS. 4A-4C describe an exemplary procedure 400 for the establishment and usage of a control plane over NIN3A in a simplified MA PDU session 398 established over a 3GPP access.

Steps A describe the establishment of a QUIC-CP capable (e.g., multi access) simplified PDU session over a 3GPP access and NIN3A access.

In step A.1, the WTRU 302 application initiates the establishment of an application flow with a remote peer 399.

In step A.2, the WTRU 302 selects a UE route selection policy (URSP) rule for this application flow. The selected URSP rule may include an indication that QUIC-CP can or should be used. The selected URSP rule may also include an indication that NIN3A can or should be used.

In some other cases (not pictured here), instead of steps A.1 and A.2, the network may trigger the PDU session establishment or modification of step A.3, e.g., based on a message from an AF or other Core Network NF.

In step A.3, the WTRU 302 sends a (e.g., multi-access) PDU session establishment or modification request, which may include a QUIC-CP capability or indication and may include a NIN3A capability or indication.

In step A.4, based on the request (e.g., based on the QUIC-CP and/or NIN3A capability or indication) and/or policy (e.g., based on a PCC rule including a QUIC-CP and/or NIN3A capability or indication), the SMF 383 determines to use QUIC-CP for this PDU session. The SMF 383 selects a UPF 384 that supports QUIC-CP, based on the QUIC-CP capability of the UPF 384 (e.g., configured in SMF 383 by the operator, provided by UPF 384 over N4, or configured in NRF by the operator).

In steps A.5-A.7, the SMF 383 sends an N4 message to the UPF 384, including a QUIC-CP indication. Based on the QUIC-CP indication, the UPF 384 configures itself to accept a QUIC-CP establishment request from the WTRU 302. The UPF 384 sends an N4 response message to the SMF 383, e.g., indicating the success of the operation.

In step A.8, the SMF 383 sends a PDU session establishment and/or modification response message to the WTRU 302, including a QUIC-CP indication. The QUIC-CP indication may include additional QUIC-CP parameters, e.g., listing the operations that are available on the QUIC-CP stream. The response also includes usual IEs, such as the steering functionality (e.g., MPQUIC) and steering mode. At this point, in this example, the PDU session is established (or modified), between the WTRU 302 and the UPF 384, over the 3GPP access.

In step A.9, the WTRU 302 establishes an MPQUIC connection over the 3GPP access, to complete the establishment of the PDU session leg over the 3GPP access. Alternatively, if A.3 was a PDU session modification message, the WTRU 302 may create a QUIC stream on an existing MPQUIC connection to transport the application flow.

In step A.10, the WTRU 302 establishes the PDU session leg over the NIN3A access. For example, the WTRU 302 connects to the UPF 384 over a new path of the MPQUIC connection from step A.9.

In step A.11, the WTRU 302 and remote peer 399 send application traffic to each other, over the PDU session. The WTRU 302 and UPF 384 forwards PDUs of the application traffic over the 3GPP access and/or NIN3A access of the PDU session, based on the steering mode for UL traffic (e.g., in WTRU 302) and DL traffic (e.g., in UPF 384).

Steps B describe the establishment of a QUIC-CP stream. While the steps B describe a WTRU-initiated QUIC-CP stream, in some implementations, the network may determine to establish a QUIC-CP stream and may initiate the establishment of the QUIC-CP stream as described herein (e.g., decision to establish a QUIC-CP stream and/or establishment of a QUIC-CP stream).

In step B.1, a trigger occurs, for the QUIC-CP stream establishment, as described herein (e.g., decision to establish a QUIC-CP stream). For example, the WTRU 302 loses its connection to the 3GPP access.

In step B.2, the WTRU 302 sends a QUIC-CP stream establishment message to the UPF 384, as described herein (e.g., establishment of a QUIC-CP stream). For example, the WTRU 302 sends an HTTP CONNECT request message, including a QUIC-CP indication.

In step B.3, the UPF 384 accepts the establishment of the QUIC-CP stream (e.g., based on the UPF 384 being configured in step A.6). Additionally, the UPF 384 may send an indication to the SMF 383, to indicate that the QUIC-CP stream has been created. The SMF 383 may send a reply to the UPF 384, e.g., including a list of the operations available on the QUIC-CP stream.

In step B.4, the UPF 384 sends a response message, e.g., an HTTP “200 OK” message. The response message may include additional QUIC-CP parameters, e.g., listing the operations that are available on the QUIC-CP stream.

Steps C describe a WTRU-initiated procedure over a QUIC-CP stream.

In step C.1, the WTRU 302 determines to establish, modify, or release the PDU session. For example, the WTRU 302 may desire to change the NIN3A connectivity timer value, or to modify some other aspect of the PDU session, or other operations described herein (e.g., control plane messages and operations supported over QUIC-CP).

In step C.2, the WTRU 302 sends a CP request message to the UPF 384, over the QUIC-CP stream. The CP request message contains IEs that execute the determined PDU session establishment, modification, or release, and may be based on related control plane messages over N2 when applicable (e.g., PDU session establishment, modification, or release messages). In some other cases, the CP request message may include new IEs, e.g., for operations without equivalent message over N2, such as NIN3A connectivity timer update. In the example of a NIN3A connectivity timer update, the IEs included in the CP request may include a request type (e.g., “NIN3A connectivity timer update”) and a timer value.

In steps C.3-C.4, the UPF 384 forwards the CP request message to the SMF 383 over N4 as described herein (e.g., N4 session enhanced for QUIC-CP). In some implementations, the UPF 384 may translate the CP request message, e.g., it may change CP-messages format between JSON (transported over the QUIC-CP stream) and the (e.g., NAS) message format (transported over N4). In other systems, the WTRU 302 and SMF 383 may be able to decode QUIC-CP messages in the same format (e.g., JSON), and there is no requirement for translation, which can be more efficient.

In step C.5, the SMF 383 receives the CP request message and implements the operation based on the CP request message content (as described herein, e.g., control plane messages and operations supported over QUIC-CP).

In steps C.6-C.7, the SMF 383 sends a CP response, which is forwarded (and, in some implementations, translated) by the UPF 384 to the WTRU 302 over the QUIC-CP stream.

In step C.8, the WTRU 302 receives the CP response message and implements the operation based on the CP response message content (e.g., it may update the NIN3A connectivity timer value based on the effective NIN3A connectivity timer value placed in the CP response message by the SMF 383).

Steps D describe a network-initiated procedure over a QUIC-CP stream.

In step D.1, the SMF 383 determines to initiate a modification or release of the PDU session, over QUIC-CP. For example, the SMF 383 may decide to use QUIC-CP because the 3GPP access is not available or congested.

In steps D.2-D.3, the SMF 383 sends a CP notification message including the IEs that execute the determined network-initiated PDU session establishment, modification or release, and may be based on related NAS control plane messages when applicable (e.g., PDU session establishment, modification or release messages). The UPF 384 forwards (and, in some implementations, translates) the CP notification message to the WTRU 302 over the QUIC-CP stream.

In step D.4, the WTRU 302 receives the CP notification message and implements the operation based on the CP notification message content.

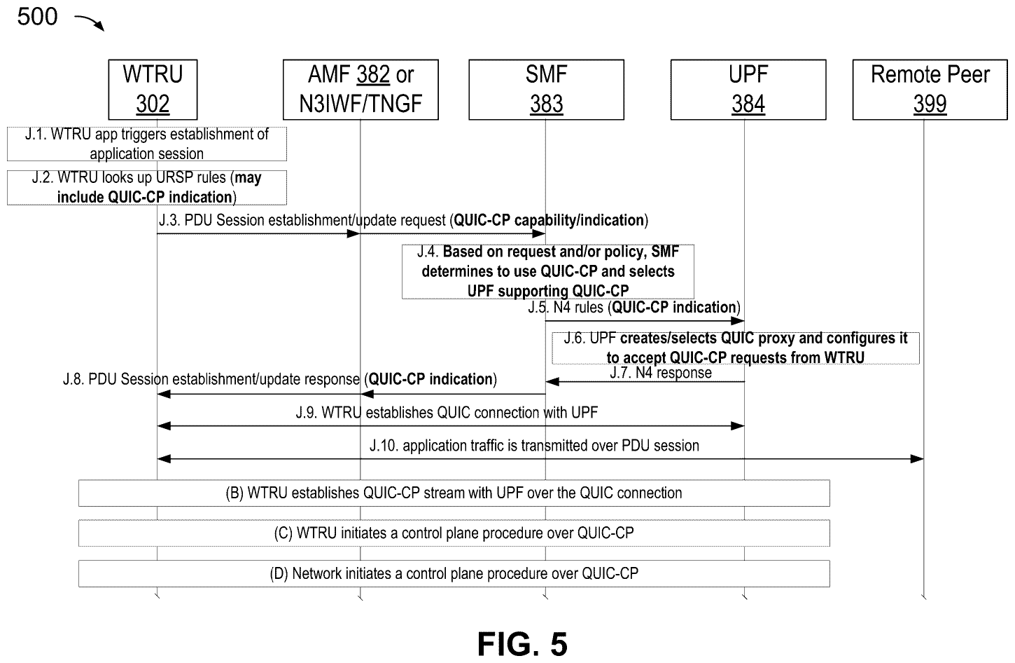

In certain representative embodiments, establishment and usage of QUIC-CP on a PDU session are provided. For example, FIG. 5 describes an exemplary procedure 500 for the establishment and usage of a QUIC control plane for a PDU session over 3GPP or non-3GPP access. The PDU session may be a regular (e.g., non-multi access) PDU session. The PDU session may be a multi access PDU session using the MPQUIC steering functionality.

Steps J describe the establishment of a QUIC-CP capable PDU session.

The procedure described by steps J is similar to the procedure described by steps A. Descriptions of like steps are omitted for brevity. Additional details follow.

The procedure described by steps J enables the establishment of a (e.g., regular, non-multi-access) PDU session, corresponding to the scenario #3 described herein (e.g., exemplary scenarios setup and QUIC-CP capabilities and indications). To make this PDU session QUIC-CP capable, the user plane traffic of the PDU session is transported over a QUIC connection between WTRU 302 and UPF 384, similarly to an MA PDU session 398 using the MPQUIC steering mode.

In step J.6 a QUIC proxy (or select an existing QUIC proxy) is created. The QUIC proxy is not usually used for non-multi-access PDU sessions. That is, for example, the QUIC proxy is provided for non-multi-access PDU sessions.

A QUIC connection is used, which may not be a multi-path QUIC connection, since a single leg is used over the 3GPP access or over the (e.g., integrated) non-3GPP access.

Otherwise, steps J.1-9 are similar to steps A.1-9. Step J.10 is similar to step A.11.

From this point on, the WTRU 302 establishes a QUIC-CP stream with the UPF 384 over the QUIC connection (as described herein as steps B). The WTRU 302 can initiate a control plane procedure over QUIC-CP (as described herein as steps C). The SMF 383 can initiate a control plane procedure over QUIC-CP (as described herein as steps D).

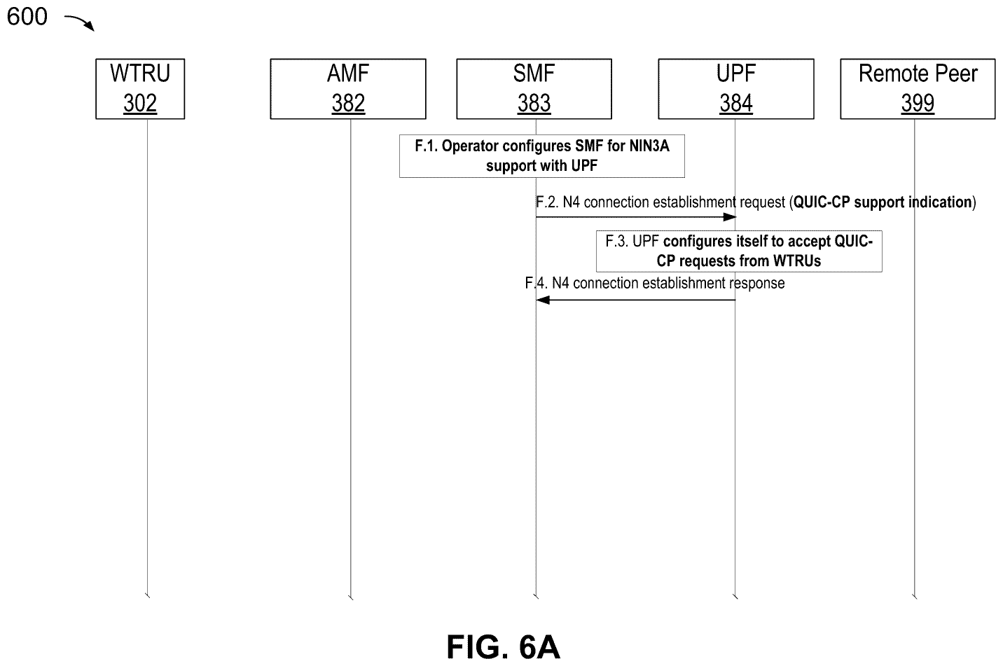

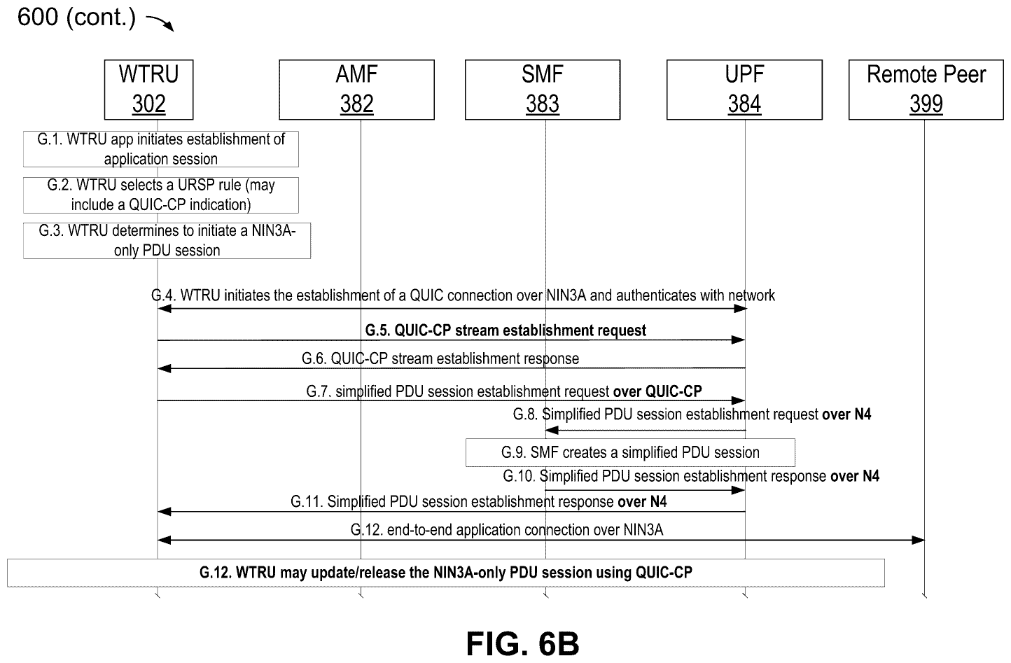

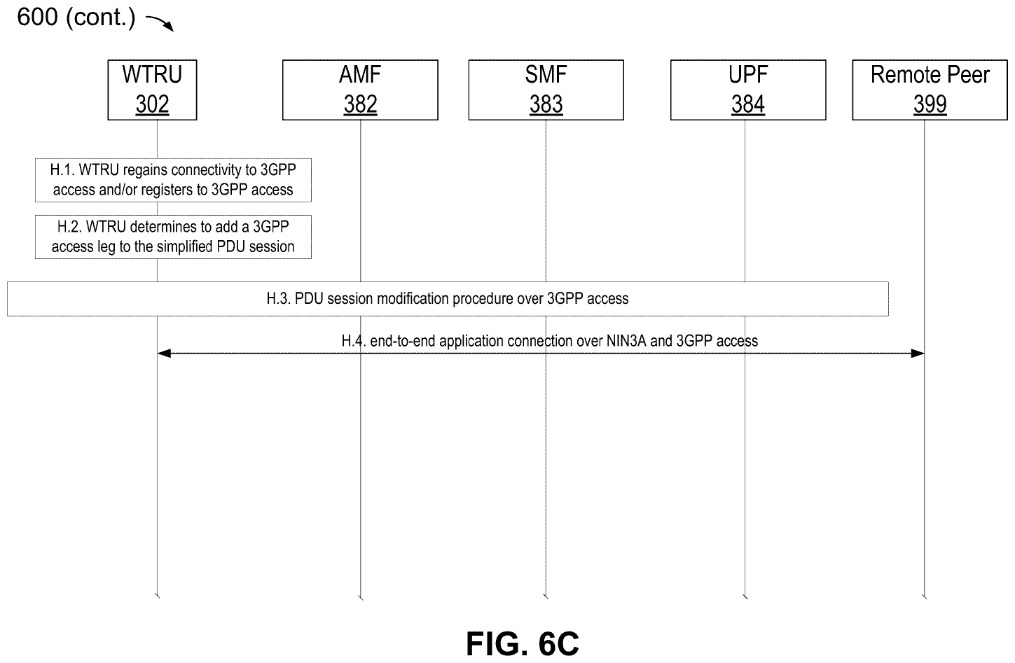

In certain representative embodiments, establishment and usage of QUIC-CP on a NIN3A-initiated simplified MA PDU session are provided. For example, FIGS. 6A-6C describe an exemplary procedure 600 for the establishment and usage of a control plane over NIN3A, in a simplified MA PDU session 398 established over NIN3A.

Steps F describe the establishment of the N4 session between the SMF 383 and the UPF 384, to enable establishing simplified PDU connection over NIN3A.

In step F.1, the operator configures the SMF 383 for NIN3A support with the UPF 384. This configuration indicates that the SMF 383 will listen to CP request messages from WTRUs through the UPF 384.

In steps F.2-F.3, the SMF 383 establishes a long-term N4 connection with the UPF 384. This N4 connection is not associated with a PDU session. The N4 connection establishment request includes a QUIC-CP support indication. The UPF 384 configures itself to listen to QUIC-CP requests from WTRU 302 and sends a response to the SMF 383 (e.g., including a success code). Steps G describe the establishment of a simplified PDU session over NIN3A.

In steps G.1-G.3, the WTRU 302 application initiates the establishment of an application session with a remote peer 399. The WTRU 302 selects a URSP rule matching the application session. The selected URSP rule may include a QUIC-CP indication and may include a NIN3A indication, which indicates that the WTRU 302 may use NIN3A and/or may initiate a PDU session over NIN3A. The WTRU 302 determines to initiate a NIN3A-only PDU session, e.g., because the 3GPP access is not available, and/or based on the NIN3A indication.

In step G.4, the WTRU 302 establishes a QUIC connection over the NIN3A access, with the UPF 384. The WTRU 302 authenticates over the QUIC connection (e.g., using the secondary authentication procedure of the PDU session establishment, over the QUIC connection).

Steps G.4-G.6 are based on the procedure described in steps B.

In steps G.7-G.11, which are based on the procedure described in steps C, the WTRU 302 sends a “simplified PDU session establishment request” CP message to the SMF 383 through UPF 384, and the SMF 383 creates a simplified PDU session and sends a response to the WTRU 302. The term “simplified” is used to indicate that the CP message may include a subset of the IEs of a PDU session establishment request or response, and to indicate that the PDU session may include a subset of the features of a usual PDU session (e.g., since the only active PDU session leg does not have a RAN node). The simplified PDU session establishment request may include a PDU session ID. When creating the PDU session, as usual, the SMF 383 may store the PDU session ID and the SMF 383 ID in unified data management (UDM), to later enable retrieving the SMF 383 corresponding to the PDU session ID.

In step G.12, the WTRU 302 and remote peer 399 exchange application traffic over the simplified PDU session over the NIN3A access. Also, for example, in step G.12, the WTRU 302 may update (e.g., modify) and/or release the NIN3A-only PDU session using QUIC-CP.

Steps H describe how, after regaining its 3GPP access, the WTRU 302 can use the PDU session modification procedure to modify the existing NIN3A-only simplified PDU access into a fully functional simplified MA PDU access over 3GPP access and NIN3A.

In steps H.1-H.2, the WTRU 302 regains connectivity to the 3GPP access (e.g., registers to the 3GPP network over the 3GPP access). The WTRU 302 determines to add a new leg to the simplified PDU session, for example, based on the fact that the 3GPP access was regained.

In step H.3, the WTRU 302 initiates a PDU session modification procedure over the 3GPP access, e.g., using the PDU session ID. The AMF 382 determines the SMF 383 using the SMF 383 ID-PDU session ID linkage stored in the UDM. The SMF 383 updates the PDU session to include both the 3GPP access and the NIN3A access. From this point on, the WTRU 302 may further modify or release the PDU session using the 3GPP access control plane.

In step H.4, the WTRU 302 and remote peer 399 exchange application traffic over the PDU session over the 3GPP access and NIN3A access.

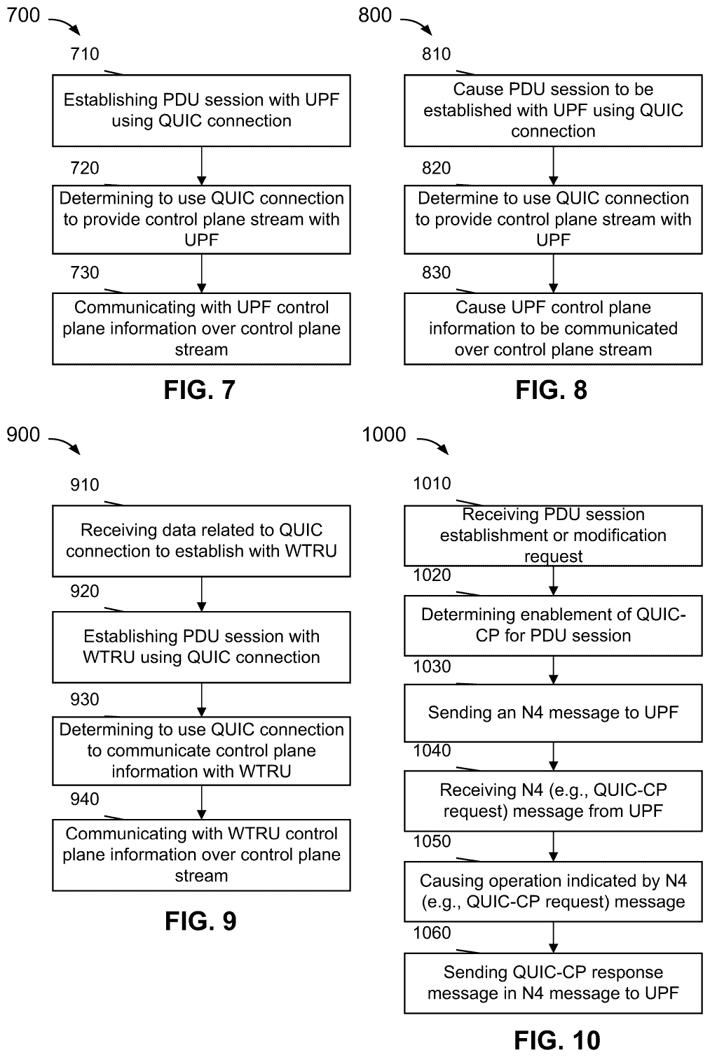

FIG. 7 is a procedural diagram illustrating an example procedure 700 for establishing a control plane stream between a WTRU (e.g., 302) and a UPF (e.g., 384). The procedure 700 includes establishing 710, by the WTRU, a PDU session (e.g., 398) with the UPF using a QUIC connection. The procedure 700 includes determining 720, by the WTRU, to use the QUIC connection to provide the control plane stream with the UPF. The procedure 700 includes based at least in part on the determining, communicating 730 with the UPF control plane information over the control plane stream.

FIG. 8 is a procedural diagram illustrating an example procedure 800 for establishing a control plane stream between a WTRU (e.g., 302) and a UPF (e.g., 384). The WTRU includes a processor to perform one or more functions. The procedure 800 includes causing 810 a PDU session (e.g., 398) to be established with the UPF using a QUIC connection. The procedure 800 includes determining 820 to use the QUIC connection to provide the control plane stream with the UPF. The procedure 800 includes based at least in part on the determining, causing 830 the UPF control plane information to be communicated over the control plane stream.

FIG. 9 is a procedural diagram illustrating an example procedure 900 for establishing a control plane stream between a WTRU (e.g., 302) and a UPF (e.g., 384). The procedure 900 includes receiving 910, by the UPF from an SMF (e.g., 383), data related to a QUIC connection to establish with the WTRU. For example, the data indicates to use the control plane stream between the WTRU and the UPF over the QUIC connection. The procedure 900 includes establishing 920, by the UPF, a PDU session (e.g., 398) with the WTRU using the QUIC connection. The procedure 900 includes determining 930, by the UPF, to use the QUIC connection to communicate control plane information with the WTRU. The procedure 900 includes based at least in part on the determining, communicating 940 with the WTRU the control plane information over the QUIC connection.

FIG. 10 is a procedural diagram illustrating an example procedure 1000 for establishing a control plane stream including a QUIC-CP capable SMF (e.g., 383). The procedure 1000 includes receiving 1010, at the SMF, a PDU session establishment or modification request (e.g., including a QUIC-CP capability or indication). The procedure 1000 includes determining 1020, at the SMF, enablement of QUIC-CP for this PDU session. For example, the determining 1020 may be based on the QUIC-CP capability or indication from the received request (step 1010) and/or from a policy rule. The procedure 1000 includes sending 1030, from the SMF, an N4 message to a UPF (e.g., 384). For example, the N4 message to the UPF may include a QUIC-CP indication. The procedure 1000 includes receiving 1040 an N4 message from the UPF. For example, the N4 message from the UPF may include a QUIC-CP request message from the WTRU (e.g., 302). The procedure 1000 includes causing 1050 an operation indicated by the QUIC-CP request message. For example, the operation indicated by the QUIC-CP request message may include a PDU session modification or a NIN3A connectivity timer update. The procedure 1000 includes sending 1060, from the SMF, a QUIC-CP response message in an N4 message to the UPF.

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

Each of the contents of the following references is incorporated by reference herein in their entireties: (1) 3GPP, TR 23.700-54, “Study on Multi-Access (DualSteer and ATSSS_Ph4)”; (2) IETF, RFC 9298, “Proxying UDP in HTTP”; (3) IETF, RFC 9297, “HTTP Datagrams and the Capsule Protocol”; (4) IETF, RFC 9484, “Proxying IP in HTTP”; and (5) IETF, “Proxying Ethernet in HTTP”.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6, 35 U.S.C. § 112 (f) or means-plus-function claim format, and any claim without the terms “means for” is not so intended.

What is claimed:

1. A method for establishing a control plane stream between a wireless transmit/receive unit (WTRU) and a user plane function (UPF), the method comprising:
establishing, by the WTRU, a protocol data unit (PDU) session with the UPF using a QUIC connection;
determining, by the WTRU, to use the QUIC connection to provide the control plane stream with the UPF; and
based at least in part on the determining, communicating, by the WTRU, with the UPF control plane information over the control plane stream.

2. The method of claim 1, wherein establishing the PDU session with the UPF using the QUIC connection comprises:
transmitting, by the WTRU, a request to establish the PDU session with the UPF using a QUIC proxy; and
establishing a leg of the PDU session between the WTRU and the UPF over non-integrated non-3GPP access (NIN3A).

3. The method of claim 1, wherein establishing the PDU session with the UPF using the QUIC connection comprises:
transmitting, by the WTRU, a request to establish a multi-access (MA) PDU session with the UPF using multipath QUIC (MPQUIC) steering functionality; and
establishing a leg of the MA PDU session between the WTRU and the UPF over non-integrated non-3GPP access (NIN3A).

4. The method of claim 1, wherein establishing the PDU session with the UPF using the QUIC connection comprises transmitting a request indicating to exchange control plane information between the WTRU and the UPF over the control plane stream.

5. The method of claim 1, wherein determining to use the QUIC connection to communicate control plane information with the UPF comprises detecting a predefined trigger to initiate communication of control plane information over the control plane stream.

6. The method of claim 5, wherein the predefined trigger includes at least one of losing 3GPP access connectivity, completing setting up the PDU session, modifying the PDU session, receiving a message from a network, deciding to stop using 3GPP access, deciding to not use 3GPP access, completing establishing the QUIC connection, a decision to change a NIN3A connectivity timer, or detecting a network load above a threshold.

7. The method of claim 1, wherein determining to use the QUIC connection to communicate control plane information with the UPF comprises receiving a message from the UPF instructing the WTRU to initiate communication of control plane information over the control plane stream.

8. The method of claim 1, wherein the control plane information is transmitted from the WTRU to the UPF or from the UPF to the WTRU and comprises data associated with at least one of establishing a new PDU session over the QUIC connection, modifying the PDU session over the QUIC connection, or releasing the PDU session over the QUIC connection.

9. A wireless transmit/receive unit (WTRU) for establishing a control plane stream between the WTRU and a user plane function (UPF), the WTRU comprising a processor to:
cause a protocol data unit (PDU) session to be established with the UPF using a QUIC connection;
determine to use the QUIC connection to provide the control plane stream with the UPF; and
based at least in part on the determining, cause the UPF control plane information to be communicated over the control plane stream.

10. The WTRU of claim 9, wherein establishing the PDU session with the UPF using the QUIC connection comprises the processor to:
cause a request to be transmitted to establish the PDU session with the UPF using a QUIC proxy; and
cause a leg of the PDU session to be established between the WTRU and the UPF over non-integrated non-3GPP access (NIN3A).

11. The WTRU of claim 9, wherein establishing the PDU session with the UPF using the QUIC connection comprises the processor to:
cause a request to be transmitted to establish a multi-access (MA) PDU session with the UPF using multipath QUIC (MPQUIC) steering functionality; and
cause a leg of the MA PDU session to be established between the WTRU and the UPF over non-integrated non-3GPP access (NIN3A).

12. The WTRU of claim 9, wherein establishing the PDU session with the UPF using the QUIC connection comprises the processor to:
cause a request to be transmitted indicating to exchange control plane information between the WTRU and the UPF over the control plane stream.

13. The WTRU of claim 9, wherein determining to use the QUIC connection to communicate control plane information with the UPF comprises the processor to:
cause a predefined trigger to be detected to initiate communication of control plane information over the control plane stream.

14. The WTRU of claim 13, wherein the predefined trigger includes at least one of losing 3GPP access connectivity, completing setting up the PDU session, modifying the PDU session, receiving a message from a network, deciding to stop using 3GPP access, deciding to not use 3GPP access, completing establishing the QUIC connection, a decision to change a NIN3A connectivity timer, or detecting a network load above a threshold.

15. The WTRU of claim 9, wherein determining to use the QUIC connection to communicate control plane information with the UPF comprises the processor to:
cause a message to be received from the UPF instructing the WTRU to initiate communication of control plane information over the control plane stream.

16. The WTRU of claim 9, wherein the control plane information is transmitted from the WTRU to the UPF or from the UPF to the WTRU and comprises data associated with at least one of establishing a new PDU session over the QUIC connection, modifying the PDU session over the QUIC connection, or releasing the PDU session over the QUIC connection.

17. A method for establishing a control plane stream between a wireless transmit/receive unit (WTRU) and a user plane function (UPF) via a session management function (SMF), the method comprising:
receiving, by the UPF from the SMF, data related to a QUIC connection to establish with the WTRU, wherein the data indicates to use the control plane stream between the WTRU and the UPF over the QUIC connection;
establishing, by the UPF, a protocol data unit (PDU) session with the WTRU using the QUIC connection;
determining, by the UPF, to use the QUIC connection to communicate control plane information with the WTRU; and
based at least in part on the determining, communicating with the WTRU the control plane information over the control plane stream.

18. The method of claim 17, wherein establishing the PDU session with the WTRU using the QUIC connection comprises:
receiving, from the WTRU, a request to establish the PDU session with the UPF using a QUIC proxy; and
establishing a leg of the PDU session between the WTRU and the UPF over non-integrated non-3GPP access (NIN3A).

19. The method of claim 17, wherein establishing the PDU session with the WTRU using the QUIC connection comprises:
receiving, from the WTRU, a request to establish a multi-access (MA) PDU session with the UPF using multipath QUIC (MPQUIC) steering functionality; and
establishing a leg of the MA PDU session between the WTRU and the UPF over non-integrated non-3GPP access (NIN3A).

20. The method of claim 17, wherein establishing the PDU session with the WTRU using the QUIC connection comprises receiving a request indicating to exchange control plane information between the WTRU and the UPF over the control plane stream.
